(19) United States
(12) Patent Application Publication
(10) Pub. No.: US 2021/0170385 A1
(43) Pub. Date: Jun. 10, 2021

(54) FABRICATION PROCESS FOR EFFICIENT VISIBLE LIGHT PHOTOCATALYSTS

(71) Applicant: PHOTONCLEAN INC., White Rock (CA)

(72) Inventors: Duarte SOUSA, Surrey (CA); Peter MRAMOR, New Westminster (CA); Ryan VAN DER ENDE, Surrey (CA)

(21) Appl. No.: 16/706,946

(22) Filed: Dec. 9, 2019

(51) Int. Cl. B01J 37/00; B01J 21/06; B01J 23/745; B01J 35/00; B01J 6/00

(52) U.S. Cl. CPC B01J 37/0036; B01J 21/063; B01J 6/001; B01J 37/0045; B01J 35/004; B01J 23/745

(57) ABSTRACT

The present relates to the field of iron-doped TiO₂ nanocrystals/photocatalysts and to a method of their production. The method comprising the steps: a) dissolving a compound comprising Fe (III); b) mixing an alcohol to the ferric solution to obtain a mixture; c) adjusting the pH of the mixture by adding a suitable acid to the mixture to obtain an acidic composition; d) producing a gelation reaction by mixing a titanium (IV) complex to the acidic composition, to obtain a dispersion comprising Fe-doped TiO₂, e) drying the dispersion, to obtain a dried product substantially free of iron oxide contamination; f) grinding the dried product, to obtain a powder; g) washing the powder with an aqueous liquid, to obtain a washed powder comprising a Fe-doped TiO₂ photocatalyst precursor; and h) drying the washed powder, to obtain the Fe-doped TiO₂ photocatalyst precursor. The method further comprising calcining and grinding steps.

### TECHNICAL FIELD

The present application relates to the field of the production of iron-doped titanium dioxide nanocrystals that are efficient visible light activated photocatalysts.

### BACKGROUND OF THE ART

The use of titanium dioxide (TiO₂) as an efficient and benign photocatalyst has been around for decades. The production of raw TiO₂ is typically undertaken using a sulfate or chloride process. However, because of the large band gap energy (≈3.2 eV), TiO₂ shows a poor photocatalytic activity with visible light and requires UV light activation.

Activating a photocatalyst using visible light has many advantages. Expensive and potentially hazardous UV light sources can be eliminated and substituted with safe, inexpensive visible light sources. Expensive quartz glass substrates (which allow for UV light transmission) can be substituted with inexpensive soda lime glass substrates. The TiO₂ doped catalyst can even be activated through water. So, installations using visible light photocatalyst become safer, lower cost, and simpler to design. An additional advantage for the use of visible light photocatalysts is a higher catalytic activity than UV light photocatalysts.

Using the current methods for the production of iron doped titanium dioxide visible light photocatalysts, the efficiency of the photocatalyst product is inhibited by an iron oxide contamination layer on the crystal edges. Initial attempts at doping TiO₂ with iron did not improve photocatalytic activity under visible light irradiation. Therefore, it was necessary to remove the iron oxide contamination using an acid washing step for the product to have good photocatalytic efficiency.

Moradia et al. adapted the process described by Oganisian et al. and produced TiO₂ visible light photocatalysts. However, the catalysts obtained had an iron contamination level that was inhibiting the photocatalytic efficiency of the nanocrystals. Oganisian et al. initially described a sol-gel method to fabricate iron-doped TiO₂ for magnetic application purposes. When the protocol was adapted for the production of photocatalysts, Moradia et al. found that the synthesis of iron doped TiO₂ nanocrystals generates a build-up of high iron oxide content on the crystal surface (iron contamination) that greatly reduces the photocatalytic activity and that this contamination level can be significantly lowered by acid washing and thereby significantly improving the efficiency of the photocatalytic efficiency in degrading organic contaminants.

(Moradi, V., Jun, M. B., Blackburn, A., & Herring, R. A. (2018). Significant improvement in visible light photocatalytic activity of Fe doped TiO₂ using an acid treatment process. Applied Surface Science, 427, 791-799).

(Oganisian, K., Hreniak, A., Sikora, A., Gaworska-Koniarek, D., & Iwan, A. (2015). Synthesis of iron doped titanium dioxide by sol-gel method for magnetic applications. Processing and Application of Ceramics, 9(1), 43-51).

Different Fe molar % doping concentrations were tested to see if the efficiency would improve as visible light photocatalysts but the results showed no significant improvement in the photocatalysis. In the patent application CA3039505 A1 (WO2018064747 Herring et al.) a method of synthesizing acid-washed iron doped dioxide visible light photocatalysts is described wherein the method remediates the loss of photocatalytic activity of iron doped titanium dioxide and causes significantly higher photocatalytic efficiency in degrading organic contaminants by reducing iron contamination by double HCl wash.

Methods of generating Fe doped TiO₂ nanocrystals to act as visible light activated efficient photocatalyst for degrading organic contaminants in water and air would be improved if the fabrication process did not generate an iron contamination layer on the surface of the crystal during the fabrication process.

### SUMMARY

There is provided herein an improved fabrication process to current methods of production of iron doped titanium dioxide to be used as an highly efficient visible light activated photocatalyst to degrade organic contamination in water and air as the improved fabrication process does not deposit an iron contamination layer on the crystal surface. This results in simpler and more costive effect method of generating the Fe doped TiO₂.

In one aspect, there is provided a method for producing an iron doped titanium dioxide (Fe-doped TiO₂) photocatalyst, the method comprising the steps:
a) dissolving a compound comprising Fe (III) in an aqueous medium to obtain a ferric solution comprising ferric ions;
b) mixing a C₁-C₄ substituted or unsubstituted alcohol to the ferric solution to obtain a mixture comprising the ferric ions dissolved in an alcoholic solvent, the alcoholic solvent comprising the aqueous medium and the C₁-C₄ substituted or unsubstituted alcohol;
c) adjusting the pH of the mixture by adding a suitable acid to the mixture to obtain an acidic composition having an acidic pH;
d) producing a gelation reaction by mixing a titanium (IV) complex selected from the group consisting of titanium alkoxide, titanium tetrachloride, and combinations thereof to the acidic composition, to obtain a dispersion, the dispersion comprising Fe-doped TiO₂, wherein the titanium alkoxide has a structure (i)

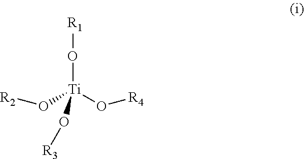

wherein R₁, R₂, R₃, and R₄ are each, identical or different, independently a substituted or unsubstituted straight or branched C₁-C₄ group;
e) drying the dispersion while removing the alcoholic solvent, to obtain a dried product substantially free of iron oxide contamination;
f) grinding the dried product, to obtain a powder;
g) washing the powder with an aqueous liquid, to obtain a washed powder comprising a Fe-doped TiO₂ photocatalyst precursor; and
h) drying the washed powder, to obtain the Fe-doped TiO₂ photocatalyst precursor.

In one embodiment, the method further comprises the steps:
i) calcining the Fe-doped TiO₂ photocatalyst precursor, to obtain a calcined substance (189) comprising an Fe-doped TiO₂ photocatalyst; and
j) grinding the calcined substance to obtain the Fe-doped TiO₂ photocatalyst.

In one embodiment, the compound comprising Fe (III) is at least one of ferric nitrite and ferric chloride.

In one embodiment, the C₁-C₄ substituted or unsubstituted alcohol is one of ethyl alcohol, 2-propanol, or butanol.

In one embodiment, the titanium (IV) complex is at least one of titanium tetraisopropoxide, titanium isobutoxide, and titanium tert-butoxide.

In one embodiment, the suitable acid is selected from the group consisting of HNO₃, HCl, and glacial acetic acid.

In one embodiment, the Fe-doped TiO₂ photocatalyst precursor has a structure consisting of TiO₂ doped with 0.25 to 20 molar % of Fe comprising a surface wherein greater than 75% of the surface is free from iron oxide contamination.

In one embodiment, the acidic pH is less than 2.

In one embodiment, step d) comprises adding the titanium (IV) complex to the acidic composition is done in less than 25 minutes.

In one embodiment, step d) lasts for about 1.5 to about 2.5 hours at a temperature of about 30° C. to about 40° C.

In one embodiment, the drying of step h) is performed at a temperature of about 75 to about 85° C. for 2 to 8 hours.

In one embodiment, the alcoholic solvent in step e) is removed in less than 10 minutes.

In one embodiment, the alcoholic solvent in step e) is removed using a conveyor process.

In a further embodiment, the conveyor process is a belt filtration.

In one embodiment, the grinding is ball milling or jet milling.

In one embodiment, the method further comprises step e1), after step e) before step f), spreading the dispersion onto drying pans.

In one embodiment, the washing in step g) comprises at least one wash cycle, the wash cycle comprising placing the powder in a mix vessel comprising a bottom surface, adding the aqueous liquid to the mix vessel, mixing the aqueous liquid and the powder to form a wash dispersion, allowing the powder to settle at the bottom surface of the mix vessel to form an effluent, and decanting and discarding the effluent.

In one embodiment, the washed powder in step h) is dried for 2 to 6 hours at a temperature of about 50° C. to about 80° C.

In one embodiment, the calcining in step i) is performed for 4 hours at a peak temperature of 400° C.

In one aspect, there is provided a method for producing an iron doped titanium dioxide (Fe-doped TiO₂) photocatalyst, the method comprising the steps:

a) dissolving a compound comprising Fe (III) in an aqueous medium to obtain a ferric solution comprising ferric ions;

b) mixing a C₁-C₄ substituted or unsubstituted alcohol to the ferric solution to obtain a mixture comprising the ferric ions dissolved in an alcoholic solvent, the alcoholic solvent comprising the aqueous medium and the C₁-C₄ substituted or unsubstituted alcohol;

c) adjusting the pH of the mixture by adding a suitable acid to the mixture to obtain an acidic composition having an acidic pH;

d) producing a gelation reaction by mixing a titanium (IV) complex selected from the group consisting of titanium alkoxide, titanium tetrachloride, and combinations thereof to the acidic composition, to obtain a dispersion, the dispersion comprising Fe-doped TiO₂, wherein the titanium alkoxide has a structure (i)

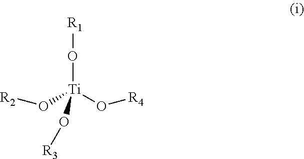

wherein R₁, R₂, R₃, and R₄ are each identical or different independently a substituted or unsubstituted straight or branched C₁-C₄ group;

e) drying the dispersion while removing the alcoholic solvent, to obtain a dried product substantially free of iron oxide contamination;

f) grinding the dried product, to obtain a powder;

g) washing the powder with an aqueous liquid, to obtain a washed powder comprising a Fe-doped TiO₂ photocatalyst precursor;

h) drying the washed powder, to obtain the Fe-doped TiO₂ photocatalyst precursor;

i) calcining the Fe-doped TiO₂ photocatalyst precursor, to obtain a calcined substance comprising an Fe-doped TiO₂ photocatalyst; and

j) grinding the calcined substance to obtain the Fe-doped TiO₂ photocatalyst.

Many further features and combinations thereof concerning the present improvements will appear to those skilled in the art upon reading the instant disclosure.

### DESCRIPTION OF THE DRAWINGS

FIG. 1 is a process flow diagram according to one embodiment of producing iron-doped titanium oxide;

FIG. 2 is a schematic representation of one embodiment of an impeller assembly described herein;

FIG. 3 is a graph of temperature as a function of time during calcining;

FIG. 4a is a graph from energy dispersive X-ray analysis of the photocatalyst of Sample 1 with the intensity in function of energy;

FIG. 4b is a high-angle annular dark-field (HAADF) microscopy image of the photocatalyst of FIG. 4a;

FIG. 4c is a microscopy image of the iron in the photocatalyst of FIG. 4a;

FIG. 4d is a microscopy image of the titanium in the photocatalyst of FIG. 4a;

FIG. 5a a high-angle annular dark-field microscopy image of the photocatalyst of Sample 2;

FIG. 5b is a graph from energy dispersive X-ray analysis of the photocatalyst of FIG. 5a with the intensity in function of energy;

FIG. 6a is a high-angle annular dark-field microscopy image of the photocatalyst of Sample 3;

FIG. 6b a graph from energy dispersive X-ray analysis of the photocatalyst of FIG. 6a with the intensity in function of energy;

FIG. 7a is an electron energy loss spectroscopy image of the photocatalyst of Sample 1;

FIG. 7b is an electron energy loss spectroscopy image of the titanium portion of the photocatalyst of FIG. 7a;

FIG. 7c is an electron energy loss spectroscopy image of e oxygen portion of the photocatalyst of FIG. 7a;

FIG. 7d is an electron energy loss spectroscopy image of the iron portion of the photocatalyst of FIG. 7a;

FIG. 8a is an electron energy loss spectroscopy (EELS) image of the photocatalyst of Sample 2;

FIG. 8b is an electron energy loss spectroscopy image of the titanium portion of the photocatalyst of FIG. 8a;

FIG. 8c is an electron energy loss spectroscopy image of e oxygen portion of the photocatalyst of FIG. 8a;

FIG. 8d is an electron energy loss spectroscopy image of the iron portion of the photocatalyst of FIG. 8a;

FIG. 8e is an electron energy loss spectroscopy image of the photocatalyst of Sample 2;

FIG. 8f is an electron energy loss spectroscopy image of the titanium portion of the photocatalyst of FIG. 8e;

FIG. 8g is an electron energy loss spectroscopy image of the oxygen portion of the photocatalyst of FIG. 8e;

FIG. 8h is an electron energy loss spectroscopy image of the iron portion of the photocatalyst of FIG. 8e;

FIG. 9a is an electron energy loss spectroscopy image of the photocatalyst of Sample 3;

FIG. 9b is an electron energy loss spectroscopy image of the titanium portion of the photocatalyst of FIG. 9a;

FIG. 9c is an electron energy loss spectroscopy image of the oxygen portion of the photocatalyst of FIG. 9a;

FIG. 9d is an electron energy loss spectroscopy image of the iron portion of the photocatalyst of FIG. 9a;

FIG. 10a is a bright field high resolution transmission electron microscopy image of Sample 1;

FIG. 10b is a bright field high resolution transmission electron microscopy image of Sample 1;

FIG. 10c is a bright field high resolution transmission electron microscopy image of Sample 1;

FIG. 10d is a bright field high resolution transmission electron microscopy image of Sample 1;

FIG. 11a is a bright field high resolution transmission electron microscopy image of Sample 2;

FIG. 11b is a bright field high resolution transmission electron microscopy image of Sample 2;

FIG. 11c is a bright field high resolution transmission electron microscopy image of Sample 2;

FIG. 11c is a bright field high resolution transmission electron microscopy image of Sample 2;

FIG. 11d is a bright field high resolution transmission electron microscopy image of Sample 2;

FIG. 12a is a graph from X-ray photoelectron spectroscopy analysis of the photocatalyst of Example 1;

FIG. 12b is a graph from X-ray photoelectron spectroscopy analysis of the photocatalyst obtained by methods of the prior art;

FIG. 13 is a graph of the colony forming units in effluent that is treated and untreated with the photocatalyst of Example 1;

FIG. 14 is a graph of the biochemical oxygen demand in effluent that is treated and untreated with the photocatalyst of Example 1;

FIG. 15 is a graph of the degradation of organic solids before and after treatment with the photocatalyst of Example 1;

FIG. 16a is a photograph of bread one week after being treated with the photocatalyst of Example 1;

FIG. 16b is a photograph of bread one week left untreated;

FIG. 17 is a photograph of glass spheres coated with photocatalyst; and

FIG. 18 is a photograph of two solutions, the experimental results of the methyl orange test, for a sample treated with the photocatalyst of Example 1 and a sample left untreated.

### DETAILED DESCRIPTION

Provided herein is a process of fabricating a visible light photocatalyst consisting of iron doped titanium dioxide (Fe-doped TiO₂) nanocrystals with low iron oxide. More specifically, the technology produces the nanocrystals through an adapted sol-gel method and optimum mixing, rapid solvent removal and drying methods that reduce the build-up of iron oxide while maximizing the surface area for the deposit of the iron doped titanium dioxide visible light photocatalyst with low iron oxide content.

By limiting the iron oxide contamination on the surface of the photocatalyst through optimum mixing, rapid solvent removal, and drying methods, the need for an acid wash step is eliminated. Therefore, the present process is advantageous over the previously known methods, which require acid washing, in that it is lower cost, simpler to perform, less time-consuming to perform, and safer for the personnel.

By contrast, current methods require an acid wash step to maximize the surface area of the resulting nanocrystals to remove the iron oxide contamination from the surface.

The nanocrystals obtained by the present process are iron-doped titanium dioxide (Fe-doped TiO₂) photocatalysts having a structure consisting of TiO₂ doped with 0.25 to 20 molar % Fe, preferably 0.4 to 5 molar % Fe, more preferably 0.5 to 2.5 molar % Fe and a surface substantially free from iron oxide contamination. “Surface substantially free from iron oxide contamination” is defined as greater than 80%, preferably greater than 85%, more preferably greater than 90%, even more preferably greater than 95%, and most preferably greater than 99% of the surface is free of iron oxide contamination.

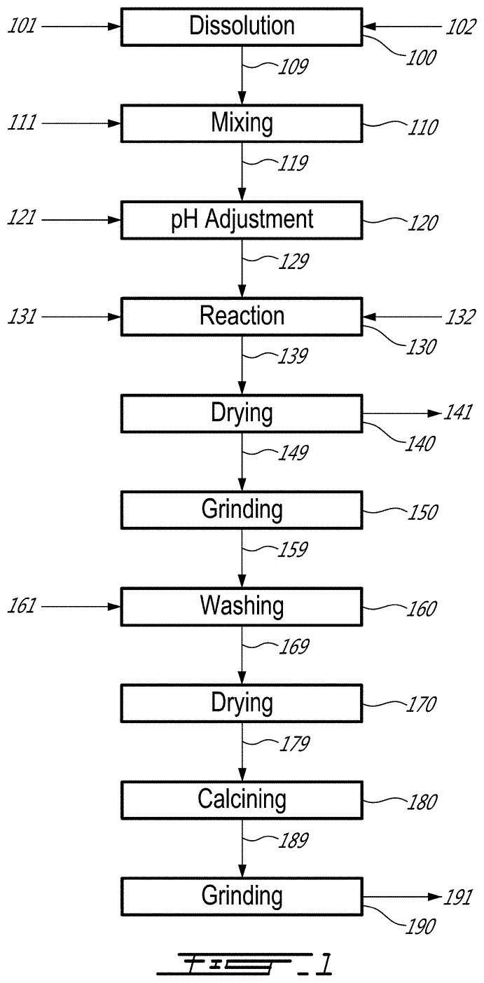

Provided herein is a method combining an adaptation of the sol-gel method with further steps of mixing and solvent removal. Referring to FIG. 1, a compound comprising Fe (III) (101) is dissolved (100) in an aqueous medium (102) to obtain a ferric solution (109) that comprises ferric ions. In one embodiment the compound comprising Fe (III) (101) comprises ferric nitrite (Fe(NO₃)₃.9H₂O), ferric chloride or a combination thereof. In one embodiment, the aqueous medium (102) is deionized (DI) water or distilled water. In a further embodiment, the dissolution is carried in a vessel that has control on the temperature of its content (for example a water-jacketed vessel). The dissolution (100) may comprise stirring the aqueous medium to dissolve Fe (III).

Then, an alcohol (111) is mixed (110) with the ferric solution (109) to obtain to a mixture (119) that comprises the ferric ions dissolved in an alcoholic solvent (141). The alcoholic solvent (141) comprises the aqueous medium (102) and the alcohol (111). In one embodiment, the alcohol is a C₁-C₄ substituted or unsubstituted alcohol. In a preferred embodiment the alcohol is at least one of ethyl alcohol, 2-propanol or butanol.

The pH of the mixture (119) is then adjusted (120) by adding a suitable acid (121) to obtain an acidic composition (129) characterized in that it has an acidic pH. In one embodiment, the suitable acid is HNO₃, HCl, or glacial acetic acid. In a preferred embodiment, the acidic pH is less than 2, preferably less than 1.8, more preferably less than 1.6, and most preferably less than 1.5.

A gelation reaction (130) is produced by mixing a titanium (IV) complex (131) selected from the group consisting of titanium alkoxide, titanium tetrachloride, and combinations thereof to the acidic composition (129), to obtain a dispersion (139). The dispersion (139) comprises Fe-doped TiO₂. The titanium alkoxide has a structure (i) where R₁, R₂, R₃, and R₄ are each, identical or different, independently a substituted or unsubstituted straight or branched C₁-C₄ group. In a preferred embodiment the titanium alkoxide is at least one of titanium tetraisopropoxide, titanium isobutoxide, and titanium tert-butoxide.

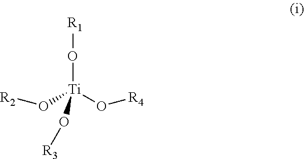

In a preferred embodiment mixing the titanium (IV) complex (131) with the acidic composition (129) is performed with an impeller providing turbulent mixing, creating a strong vortex. In this preferred embodiment, the impeller design is important to achieve rapid high viscosity (greater than 500 centipoise) mixing. Before the Ti is added, the dispersion exhibits low viscosity under 100 centipoise. As the Ti is added, the dispersion begins to thicken. By “rapid” we mean that as the Ti is added, it is quickly and uniformly distributed throughout leading to a homogeneous distribution of Ti. Mixing exhibits no cavitation with the proper impeller design. More than one impeller may be used to deliver uniform mixing throughout the head of the solution as it thickens, for example 2 or 3 impellers. The impeller may be placed slightly off-centre to further improve mixing. In a preferred embodiment of the impeller, the diameter of the impeller is about half of the diameter of the vessel.

In a preferred embodiment the mixing of the titanium (IV) complex (131) with the acidic composition (129) is performed by adding titanium (IV) complex (131) gradually over a maximum time of 1 hour, preferably 45 minutes, more preferably 35 minutes, even more preferably 30 minutes, and most preferably 25 minutes. A metering pump may be used with multiple dosing points to control the total time of addition of the titanium (IV) complex (131) to the acidic composition (129) to be less than the maximum time.

In a further preferred embodiment, the mixing of the titanium (IV) complex (131) with the acidic composition (129) is performed for about 1.5 hours to about 2.5 hours at a temperature of about 10° C. to about 60° C., preferably about 20° C. to about 50° C., and most preferably about 30° C. to about 40° C. It is desirable to maintain the temperature in these ranges to keep the viscosity low enough to prevent cavitation. In an embodiment where a water-jacketed vessel is used, warm water may be circulated in the water jacket to control the temperature by providing heat (132).

It is desired to obtain a rapid reaction rate of gelation reaction for the formation of iron-doped titanium oxide photocatalysts, this can be achieved in part due to the impeller design and to the temperature that keeps the viscosity low enough to prevent cavitation. At a constant temperature of 30° C., the time required for the gelation reaction is measured in minutes. At T=0, the viscosity is less than 100 cP (mixer rpm=600). At 50 minutes, the viscosity rises to approximately 500 cP (the mixer rpm can be raised to 650 rpm). At 1 hour, the gelation reaction is generally complete (mixer speed=700 rpm).

After the gelation reaction (130), a dispersion (139) is obtained. The dispersion is then dried (140) at a temperature between about 65° C. to about 95° C., preferably about 70° C. to about 90° C., more preferably about 75° C. to 85° C., most preferably about 77.5° C. to about 82.5° C. for a time between about 2 to about 8 hours, to obtain a dried product (149). At the conclusion of the mix and starting at the same time as drying (140), the alcoholic solvent (141) is rapidly removed which prevents the large-scale formation of iron oxide contamination and maximizes the surface area of the nanocrystals. “Rapidly removed” herein is defined to be removed in less than 30 minutes, preferably in less than 20 minutes, more preferably in less than 15 minutes, most preferably in less than 10 minutes. The alcoholic solvent is removed preferably by a conveyor process. Conveyor drying can minimize drying time by simply building a longer conveyor drying oven. Conveyor drying is desired as it is a “continuous” manufacturing process: that is, the product can be dispensed from the mixer onto the moving conveyor in a continuous manner. This allows, immediately following solvent removal, for a maximization of the surface area of the Fe-doped TiO₂ photocatalysts. It is believed that iron oxide contamination is prevented in part by limiting the reaction between the iron and the alcohol. The reaction is limited by reducing the time the reaction may take place and by having an acidic environment (for example less than 2) to possibly inhibit the reaction. In a preferred embodiment, the dispersion (139) is spread out on drying pans to improve drying (140) and the alcoholic solvent (141) removal. However, “batch drying” may also be used.

The dried product (149) is then ground (150) into a powder (159) using for example ball milling or jet milling. Then the powder (159) is subjected to a washing step (160) to obtain a washed powder (169). The washing step (160) comprises one or more wash cycles. A wash cycle comprises placing the powder (159) in a mix vessel comprising a bottom surface, adding an aqueous liquid (161) to the mix vessel, mixing the aqueous liquid (161) and the powder (159) to form a wash dispersion, allowing the powder (159) to settle at the bottom surface of the mix vessel to form an effluent, and decanting and discarding the effluent. In one embodiment, two wash cycles are performed. In a preferred embodiment, three wash cycles are performed. In a preferred embodiment the aqueous liquid (161) is deionized water or distilled water.

At the conclusion of the washing step (160), the washed powder (169) is dried (170) at about 50° C. to about 80° C. for about 2 to about 6 hours to obtain a Fe-doped TiO₂ photocatalyst precursor (179).

The Fe-doped TiO₂ photocatalyst precursor (179) is then subjected to calcination (180) for between about 3.5 to 4.5 hours at a peak temperature of 400° C.±5° C. to obtain a calcined substance (189). In a preferred embodiment, to allow for adequate and uniform oxygen penetration during calcination (180), the height of the Fe-doped TiO₂ photocatalyst precursor (179) powder is capped at 5 mm. Finally, the calcined substance (189) is ground (190) (for example by ball milling or jet milling) to obtain Fe-doped TiO₂ photocatalyst (191).

The Fe-doped TiO₂ photocatalyst (191) obtained are in the form of nanocrystals that are highly efficient visible light photocatalysts with low iron oxide content. The nanocrystals preferably have a size distribution of 10 nm±4 nm.

The present method does not require an acid wash step. Known methods of manufacturing highly efficient iron doped titanium dioxide visible light photocatalyst produce a material with high iron oxide content that greatly reduces the catalyst efficiency.

In the prior art, an acid wash is needed, after the fact, to remove the iron oxide and improve efficiency. The process described herein prevents the build-up of iron oxide to begin by the optimum mixing, drying, and alcoholic solvent removal described, thus negating the need to acid wash. This results in a safer, lower cost and greatly simplified fabrication method. Most acid washes are done with hydrochloric acid, therefore safety is enhanced by not having to handle hydrochloric acid which is most commonly used in the traditional approach of removing the iron oxide layer.

A simplified manufacturing method is achieved by not requiring acid washing. Acid washing involves numerous added process steps, including: a 90 minute acid washing, decanting solvent, second 90-minute acid washing, decanting solvent, first rinsing cycle, decanting solvent, second rinsing cycle, decanting solvent, third rinsing cycle, decanting solvent, and drying cycle.

Cost is lowered by having fewer process steps which saves labour, eliminating the disposal costs associated with using hydrochloric acid, lowering capital costs incurred by eliminating the acid washing tank and peripheral equipment, and by requiring less floor space. Leadtime is reduced. Potential material scrap and process yield losses associated with acid washing are eliminated.

### EXAMPLE 1

### Method for Producing Iron-Doped Titanium Oxide Photocatalyst

Table 1 summarizes the materials used in this method for producing iron-doped titanium oxide photocatalyst.

TABLE 1
Reagents used in the process for producing iron-doped titanium oxide
photocatalyst

| | Chemical | |
|---|---|---|
| Material | Formula | Type |
| Titanium (IV) Isopropoxide | Ti{OCH(CH₃)₂}₄ | 97% |
| Ferric Nitrite (III) | Fe(NO₃)₃•9H₂O) | Nonahydrate, >99.95% |
| Nitric Acid | HNO₃ | 70% |
| Ethyl Alcohol | C₂H₅OH | 200% proof |

The present example describes a method for producing TiO₂ doped with 0.5 molar % of Fe (termed Fe0.5%—TiO₂ in the table below) on a per gram basis, as shown in Table 2.

TABLE 2
Weight and molar amount of the reagents

| Amount of Fe_{0.5%}-TiO₂ | 1 | g |
|---|---|---|
| Number of mols of Fe_{0.5%}-TiO₂ | 0.01252 | mol |
| Portion of Fe | 0.5% | |
| Number of mols of Fe | 6.2605 × 10⁻⁵ | mol |
| Number of mols of Fe(NO₃)₃•9H₂O | 6.2605 × 10⁻⁵ | mol |
| Weight of Fe(NO₃)₃•9H₂O | 0.0253 | g |
| Portion of TiO₂ | 99.5% | |
| Number of mols of TiO₂ | 0.01246 | mol |
| Numer of mols of Ti{OCH(CH₃)₂}₄ | 0.01246 | mol |
| Weight of Ti{OCH(CH₃)₂}₄ | 3.5409 | g |

First, 0.0253 g of ferric nitrate (III) is added to a water-jacketed vessel. Then, 0.9114 g of distilled or deionized water is added to the vessel. The contents of the vessel are subjected to a dissolution to dissolve ferric nitrite (Ill) and form a ferric nitrate solution having ferric ions. At this stage, the pH of the ferric nitrate solution is predicted to be about 2.4 as shown in the calculations of Table 3.

TABLE 3
Calculation of the pH of the ferric nitrate solution

| 1 gram of finished crystals | quantity | |
|---|---|---|
| ethanol | 25.32 | mL |
| Ti{OCH(CH₃)₂}₄ | 3.7975 | g |
| Fe(NO₃)₃•9H₂O | 0.0253 | g |
| H₂O | 0.9114 | g |
| Addition of Fe(NO₃)₃•9H₂O | | |
| to H₂O | | |
| Molar mass of Fe(NO₃)₃•9H₂O | 403.99 | g/mol |
| Number of mols of Fe(NO₃)₃•9H₂O | 6.2605 × 10⁻⁵ | mol |
| Number of mols of Fe³⁺ | 6.2605 × 10⁻⁵ | mol |
| Mass of H₂O | 0.922 | ml |
| Volume of H₂O | 0.922 | g |
| [Fe³⁺] | 0.0679M | |
| Solubility product of Fe(OH)₃ | 1.1 × 10⁻³⁶ | ksp |
| [Fe³⁺] * [OH⁻]³ | 1.1 × 10⁻³⁶ | ksp |

| | |
|---|---|
| [OH⁻] | 2.52988 × 10⁻¹²M |
| [H⁺] | 0.00395M |
| pH | 2.403 |

Next the ethyl alcohol is added to the ferric nitrate solution which is then subjected to mixing through stirring to form a mixture comprising an alcoholic solvent comprising ethyl alcohol. The pH of the solution is predicted to be about 3.9 as shown in the calculations in Table 4 that neglects OH⁻ or H⁺ dissociated in the alcohol solution.

TABLE 4
Calculation of the pH the mixture

| H⁺ | 3.643 × 10⁻⁶ mol |
|---|---|
| Volume of alcoholic solvent | 26.238 mL |
| [H⁺] | 0.0001388M |
| pH | 3.858 |

Then, 0.0948 g of 70% nitric acid is added to the mixture to perform a pH adjustment to obtain an acidic composition comprising ethyl alcohol and dissolved ferric nitrite. The acidic composition is expected to have a pH of about 1.4 as shown in the calculation in Table 5.

TABLE 5
Calculation of the acidic composition

| | | |
|---|---|---|
| HNO₃ | 63.01 | g/mol |
| HNO₃ | 0.001053 | mol |
| H⁺ | 0.001053 | mol |
| 70% HNO₃ density | 1.413 | g/mL |
| 70% HNO₃ volume | 0.06709 | mL |
| Volume of H₂O, ethanol and HNO₃ | 26.305 | mL |
| Total H⁺ | 0.001057 | mol |

| | |
|---|---|
| [H⁺] | 0.04018M |
| pH | 1.4 |

The acidic composition is then mixed with turbulent mixing to create a strong vortex. The impeller design is allows for rapid (600 to 800 RPM) high viscosity mixing. For a standard two-litre vessel half-full of solution used in this example, a recommended impeller design is shown in FIG. 2. A paddle assembly (200) is shown in FIG. 2 having a diameter of ¼ of an inch of the 303/304 SS high-efficiency paddle assemblies of Cole Parmer. It is preferable for this Example to have a shaft (202) with 2 to 3 impellers (204) used to deliver uniform mixing throughout the head of the liquid as it thickens. The diameter of the impellers is about half the diameter of the vessel and may be placed off-centre to improve mixing, and at speeds of 600 to 800 RPM. The impellers (204) have their blades positioned parallel to the bottom of the vessel.

The water jacket temperature is set to 30° C. to generate heat, and the titanium (IV) isopropoxide is added into the vortex at a rate of 40 mg±20 mg per second using a metering pump with multiple dosing points to ensure that all the titanium (IV) isopropoxide can be added in at most 25 minutes. After all the titanium (IV) isopropoxide has been added, the contents of the vessel are allowed to react (gelation reaction) while mixing for 1.5 h at 700 RPM, then for 10 min at 650 RPM, and 50 min at 600 RPM for a total time of 2.5 h and at a constant temperature of 30° C. A dispersion is formed comprising iron-doped titanium oxide and by-products of the formation of iron-doped titanium oxide. As the dispersion thickens, the warm water circulating in the water jacket will keep the viscosity low enough to prevent cavitation.

The dispersion is then spread out on drying pans and subjected to drying at 80° C. for 2 to 8 hours to obtain a dried product comprising the iron-doped titanium oxide photocatalysts and by-products. The time for reaction is preferably 2.5 hours for the formation of iron-doped titanium oxide is achieved in part due to the highly efficient impeller and to the temperature of 30° C. that keeps the viscosity low enough to prevent cavitation. At the conclusion of the mix and the start of drying, the alcoholic solvent is rapidly removed (in less than 10 minutes and up to 8 hours) which prevents the large-scale formation of iron oxide contamination and maximizes the surface area of the nanocrystals. The alcoholic solvent is driven off by a conveyor process i.e. a belt filter. It is believed that iron oxide contamination is prevented in this step, in part because of the time the iron and the alcohol can react is reduced and because of the lower pH (less than 2), therefore less iron oxide is produced, and very low iron oxide contamination is present on the surface of the iron-doped titanium oxide.

The drying step will yield a dried product that is then subjected to grinding to form a powder using ball milling. Then the powder is subjected to a washing step. The washing step comprises three wash cycles. A wash cycle consists of placing the dried product in a mix vessel and adding deionized water or distilled water, for example in a weight ratio of about 50:1 (water:powder), mixing the water to form a dispersion, allowing the powder to settle to the bottom of the mix vessel to form an effluent, and decanting and discarding the effluent. A washed powder is obtained.

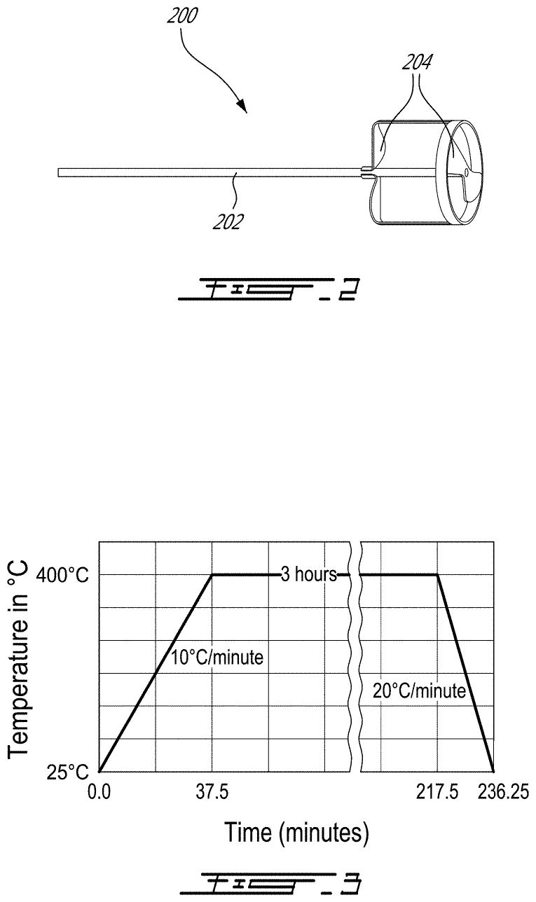

The washed powder is then subjected to drying at about 50° C. to about 80° C. for about 2 to about 6 hours to obtain a dried powder. The dried powder is then subjected to calcination using the temperature profile shown in FIG. 3 to obtain a calcined substance comprising an Fe-doped TiO₂ photocatalyst. And finally, the calcined substance is grinded by ball milling to obtain the Fe-doped TiO₂ photocatalyst.

This protocol was repeated in order to obtain three different samples referred to as Sample 1, Sample 2, and Sample 3.

### EXAMPLE 2

### Characterization of the Fe-Doped TiO₂ Photocatalyst

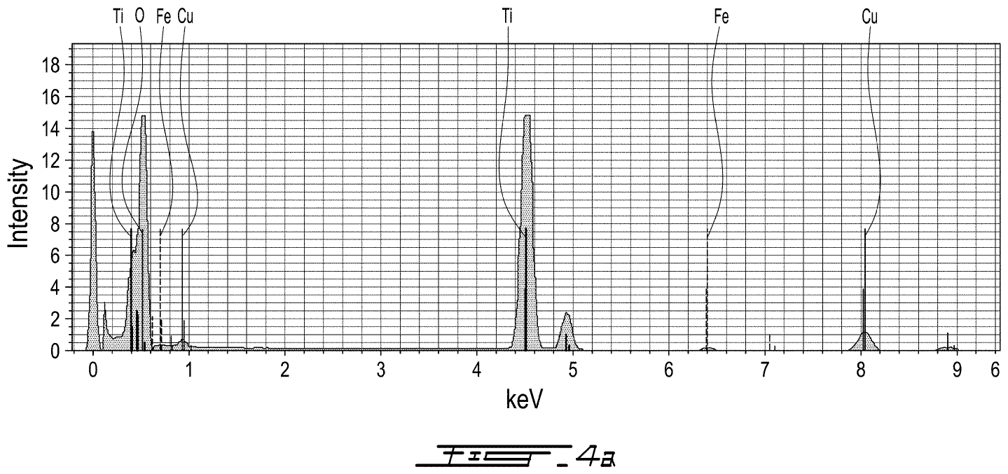

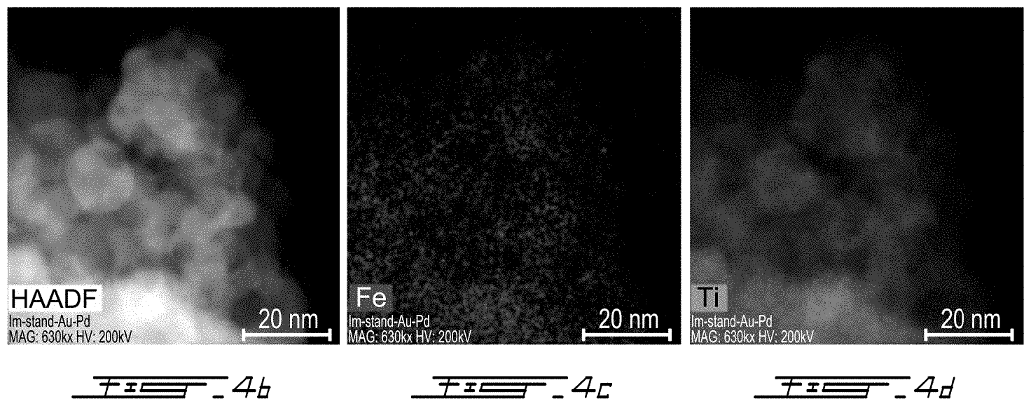

The iron-doped titanium dioxide of Sample 1 was subjected to an energy dispersive X-ray (EDX) analysis to study the exact elemental composition of the nanocrystal. The results of the EDX analysis are summarized in FIGS. 4a to 4d and in the table 6.

TABLE 6
EDX analysis results

| | | | | | | Error |
|---|---|---|---|---|---|---|
| | | | Mass C. | Nom. C. | Atom C. | (3 sigma) |
| Element | Series | Net | [wt. %] | [wt. %] | [at %] | [wt. %] |
| Fe | K | 4871 | 0.68 | 0.68 | 0.58 | 0.14 |
| Ti | K | 944542 | 99.32 | 99.32 | 99.42 | 9.02 |
| Cu+° | K | 73428 | 0.00 | 0.00 | 0.00 | |
| Si+° | K | 1420 | 0.00 | 0.00 | 0.00 | |
| | | Total | 100.00 | 100.00 | 100.00 | |

As shown in table 6 and in FIG. 4a, the Fe molar concentration was found to be 0.58% and the iron doping had a uniform distribution. The Cu at 8 keV is from the transmission electron microscopy grid and is therefore a contamination that is discarded. FIG. 4b shows the structure of the photocatalyst in a high-angle annular dark-field (HAADF) microscopy image. The microscopy image in FIG. 4c selectively shows the iron in the photocatalyst, the iron has a uniform distribution within the photocatalyst and is minimally present around the surface of the photocatalst. FIG. 4d is a fluorescent microscopy image of the titanium to show the distribution of the titanium being the major component of the photocatalsyt at 99.42 atom %. FIGS. 4a to 4d illustrate the low iron content (less than 1%) and the uniform distribution of the iron, in line with the current catalysts made from iron doping of titanium dioxide.

Sample 2 was also subjected to an energy dispersive X-ray (EDX) analysis. A high-angle annular dark-field microscopy image of the photocatalyst of Sample 2 is shown in FIG. 5a. The graph from energy dispersive X-ray analysis of the photocatalyst (FIG. 5b) demonstrated that the composition of Sample 2 in atomic % after adjusting for contamination is 67.29 O, 32.53 Ti, and 0.18 Fe.

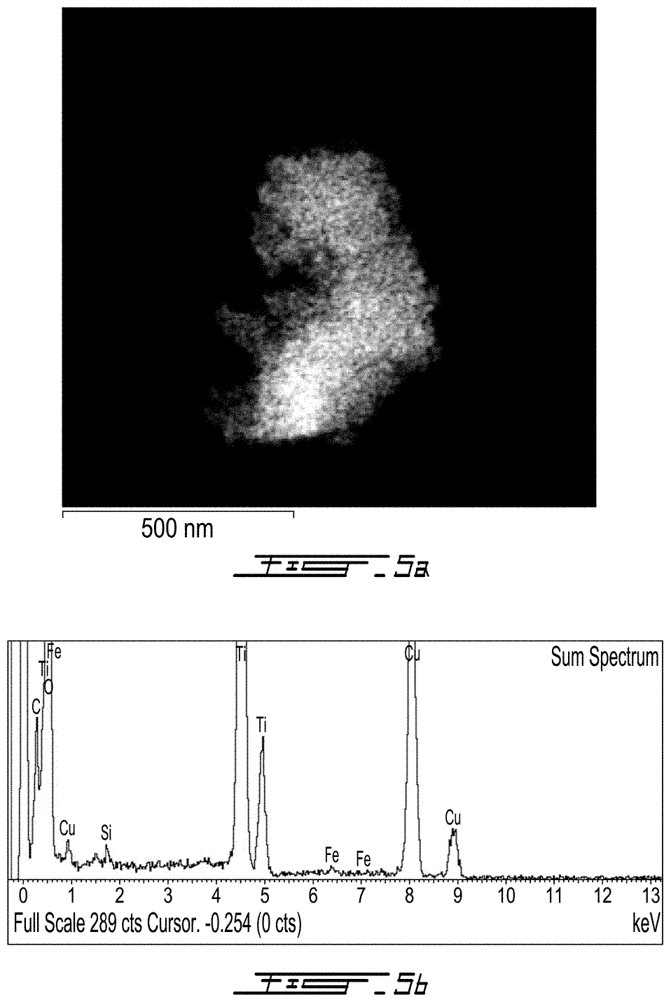

Sample 3 was also subjected to an energy dispersive X-ray (EDX) analysis. A high-angle annular dark-field microscopy image of the photocatalyst of Sample 2 is shown in FIG. 6a. The graph from energy dispersive X-ray analysis of the photocatalyst (FIG. 6b) demonstrated that the composition of Sample 3 in atomic % after adjusting for contamination is 63.57 O, 36.23 Ti, and 0.20 Fe.

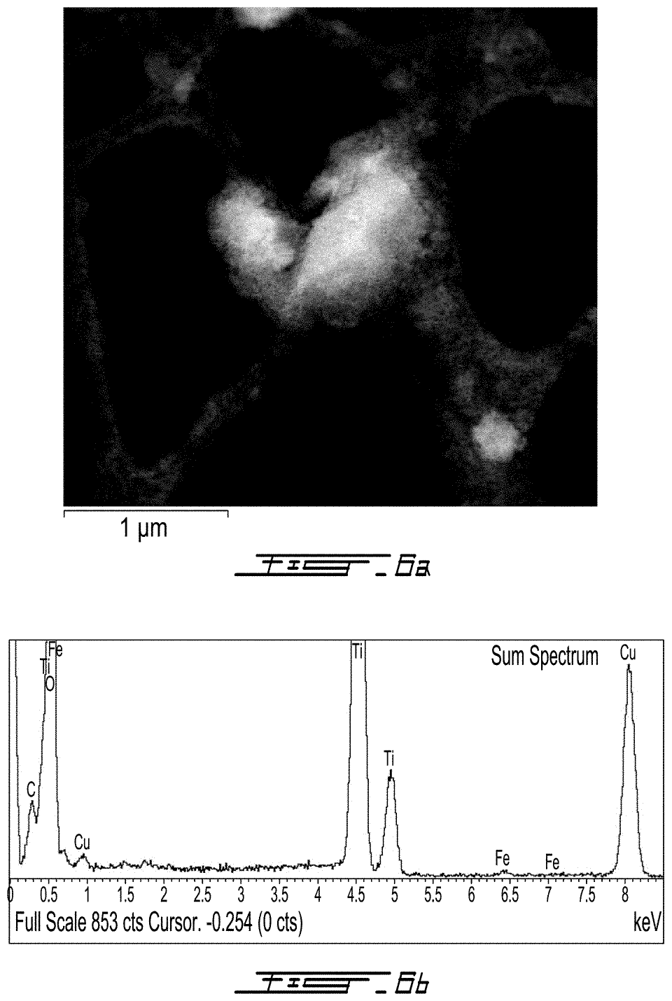

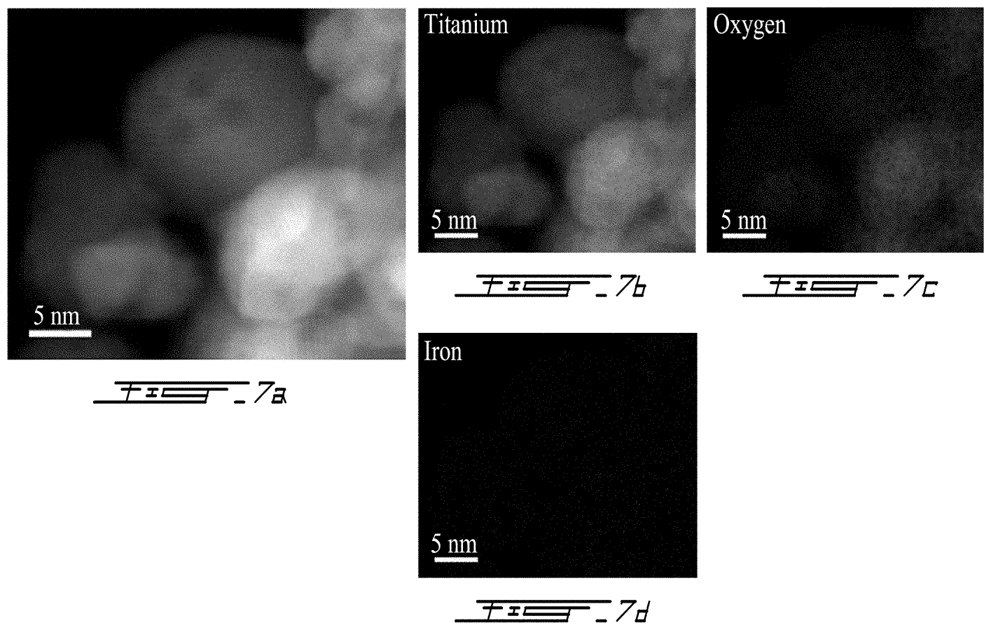

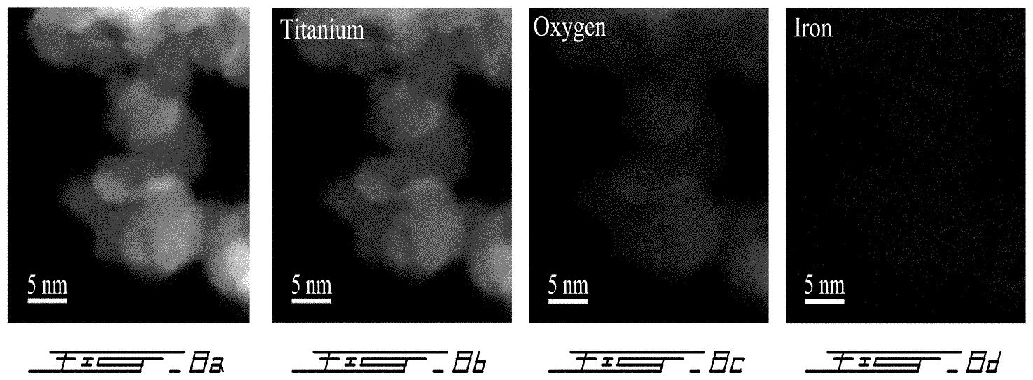

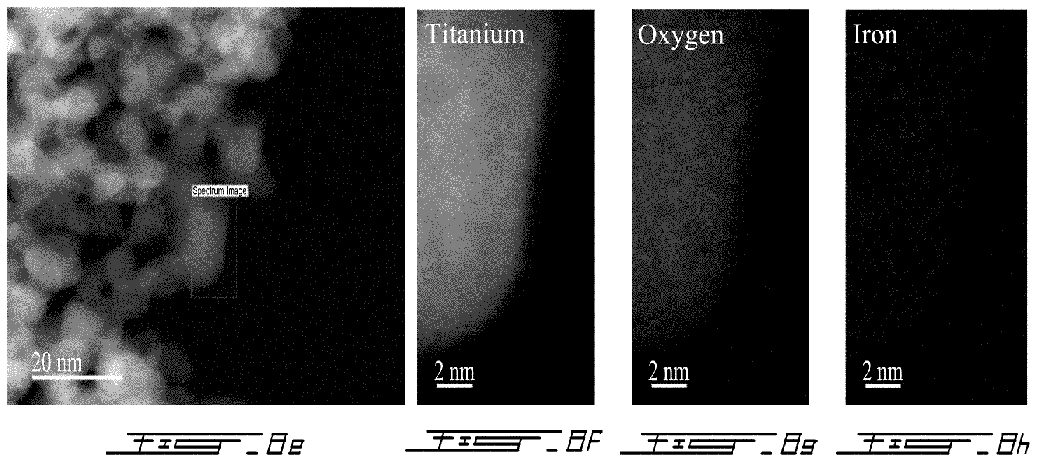

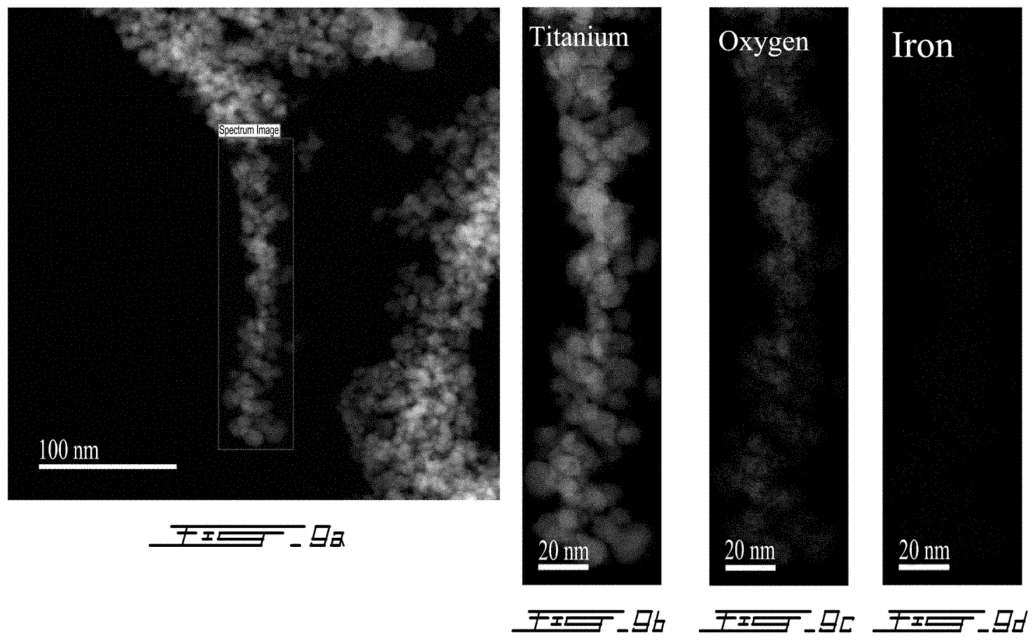

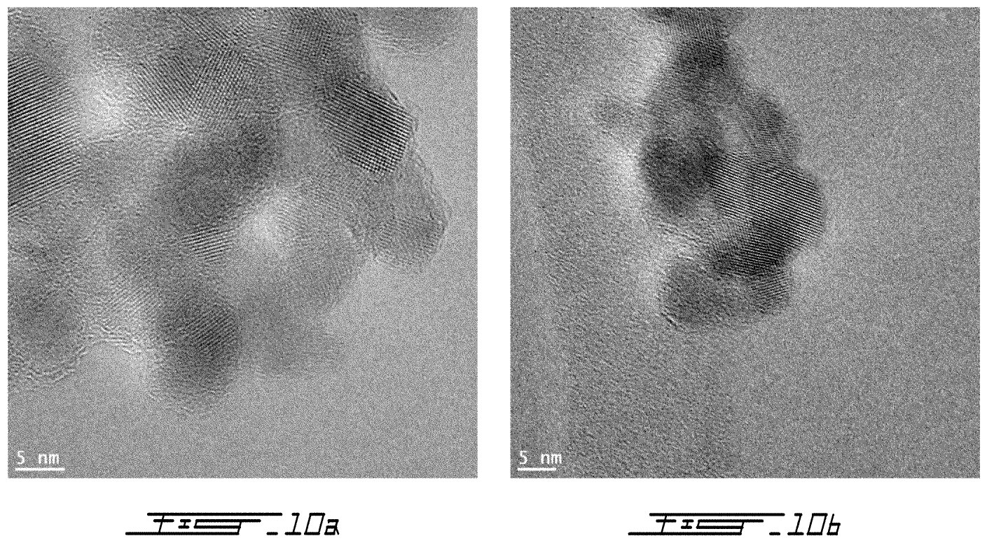

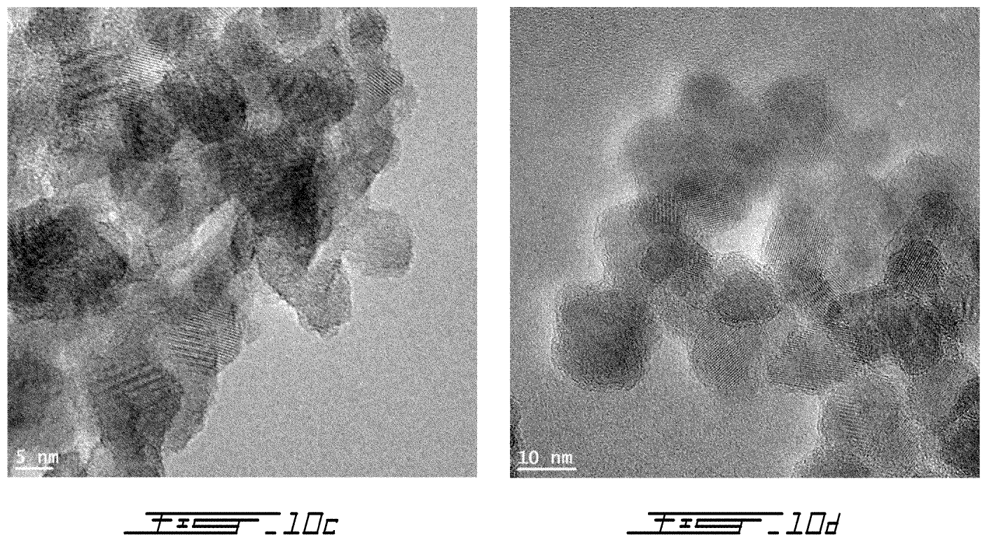

To further characterize the product of Example 1, an alternate analysis electron energy loss spectroscopy (EELS mapping) was performed on the three samples. The results are shown for Sample 1, 2, and 3 in FIGS. 7, 8 and 9 respectively . FIGS. 7a, 8a, 8e, and 9a show the EELS mapping of the photocatalyst particles of the samples. The particle diameter was found to be about 10 nm. FIGS. 7b, 8b, 8f, and 9b show the titania uniformly distributed in the particles. FIGS. 7c, 8c, 8g, and 9c show the oxygen and FIGS. 7d, 8d, 8h, and 9d show the iron, both oxygen and iron are mostly found within the particles. This demonstrates the absence of iron oxide shells. Therefore, the crystalline planes of the nanoparticles clearly go to the edge of the particle without a contamination layer of iron oxide.

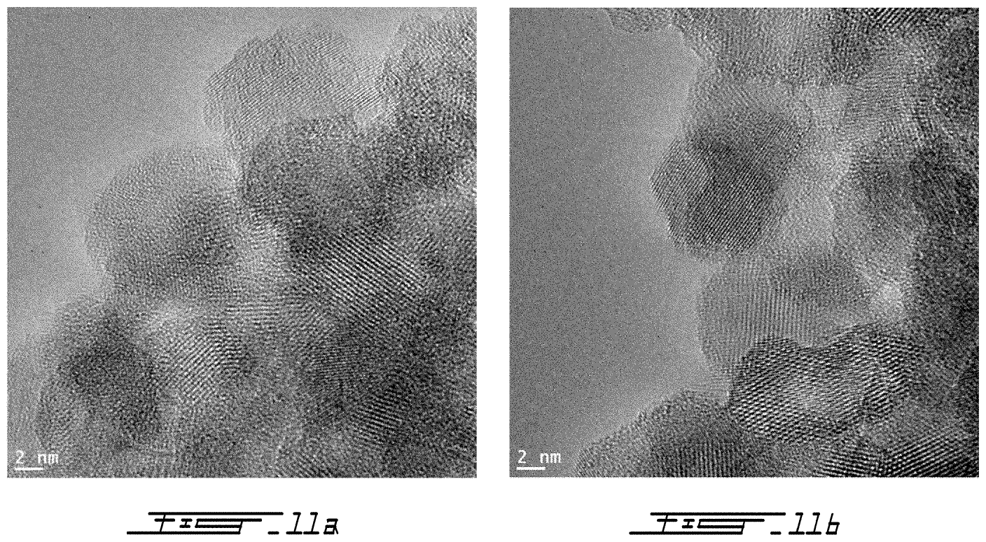

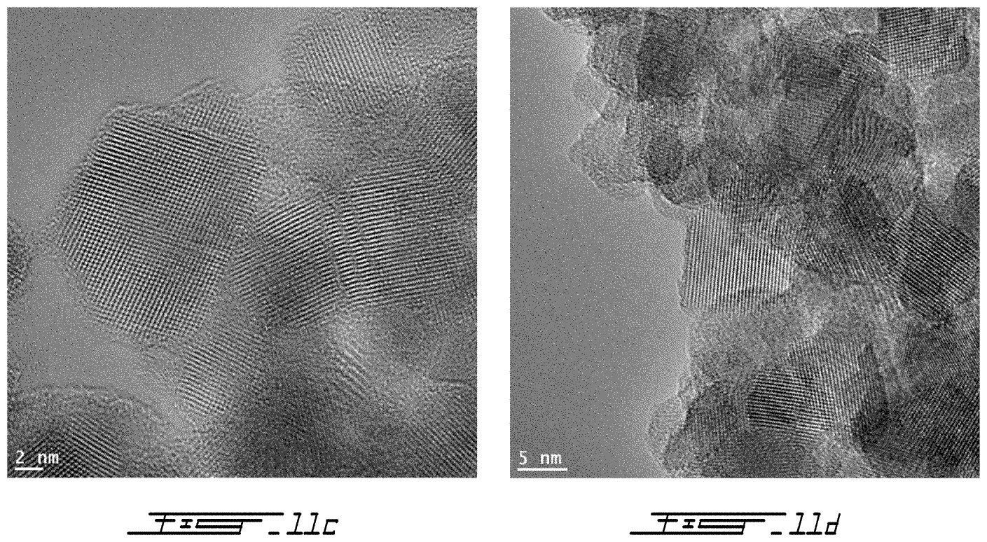

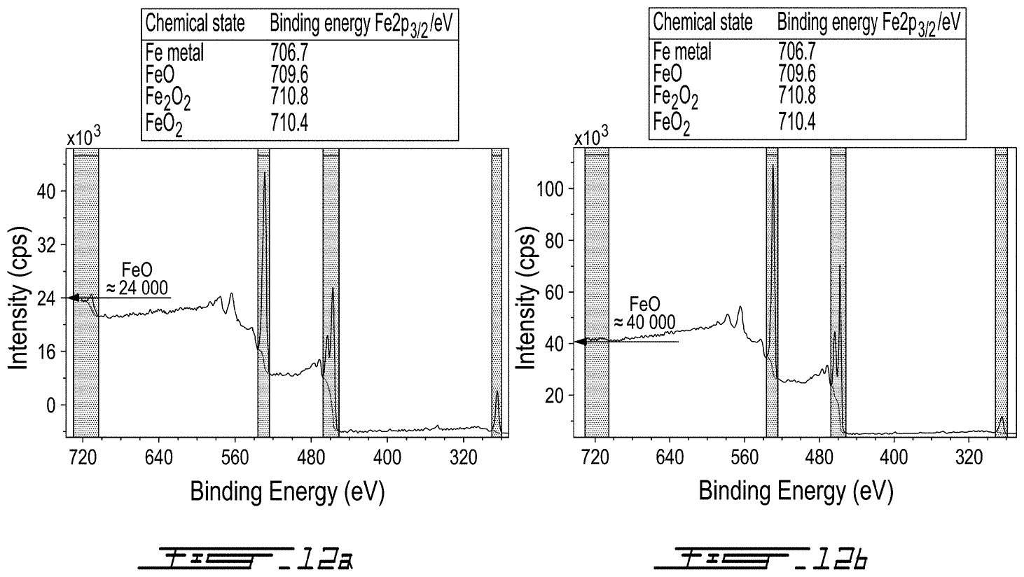

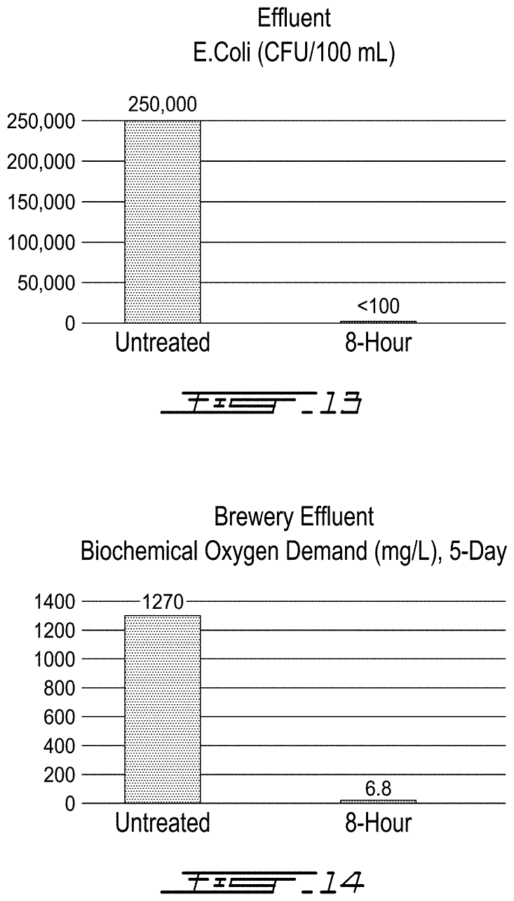

The photocatalyst product was then analysed with bright field high resolution transmission electron microscopy (BF HR-TEM). The images of Sample 2 are shown in FIGS. 10a, 10b, 10c, and 10d, and the images of Sample 3 are shown in FIGS. 11a, 11b, 11c, and 11d. These images show that crystalline planes go to the edge of particles and further demonstrate the very minimal contamination of iron oxide at the surface of the particles. A comparison is FIG. 1 from WO2018064747 (Herring et al.). FIGS. 1a and 1b of Herring et al. show a transmission electron microscopy (TEM) of the iron doped titanium dioxide nanoparticles obtained by the process of the prior art before acid washing. A large amount of iron oxide contamination can be readily seen. FIGS. 1c and 1d of Herring et al. show a TEM of the nanoparticles after the acid wash is performed. FIGS. 1c and 1d show that the contamination layer has been washed away. It is clear that the present method is an improvement over the prior art as the nanoparticles obtained by the present method show contamination levels as low or lower, than the process of the prior art after an acid wash.

Finally, X-ray photoelectron spectroscopy (XPS) was also performed to compare the product of the method of Example 1 (Sample 1) and the acid-washed product of the prior art. The XPS analysis is in FIGS. 12a and 12b is corrected for background noise. FIG. 12a is a graph from the XPS analysis of the photocatalyst of Sample 1 and FIG. 12b is a graph from the XPS analysis of the photocatalyst obtained from the traditional method that include an acid wash step. The data extracted from the FIGS. 12a and 12b is summarized respectively in tables 7 and 8.

TABLE 7
Data from FIG. 12a

| | | Position | FWHM | Raw | RSF | Atomic | Atomic | |
|---|---|---|---|---|---|---|---|---|
| Peak | Type | (BE ev) | (eV) | area | mass | numb. | conc. % | mass |
| Fe 2p | Reg | 711.000 | 4.746 | 17037.6 | 2.957 | 55.846 | 1.68 | 4.52 |
| O 1s | Reg | 529.000 | 4.468 | 137979.6 | 0.78 | 15.999 | 52.55 | 40.40 |
| Ti 2p | Reg | 457.000 | 3.912 | 111049.3 | 2.001 | 47.878 | 16.64 | 38.28 |
| C 1s | Reg | 285.000 | 3.500 | 25076.8 | 0.278 | 12.011 | 29.12 | 16.81 |

(BE = binding energy and FWHM = full width at half maximum)

TABLE 8
Data from FIG. 12b

| | | Position | FWHM | Raw | RSF | Atomic | Atomic | |
|---|---|---|---|---|---|---|---|---|
| Peak | Type | (BE ev) | (eV) | area | mass | numb. | conc. % | mass |
| Fe 2p | Reg | 715.800 | 9.874 | 20664.6 | 2.957 | 55.846 | 1.11 | 2.73 |
| O 1s | Reg | 529.800 | 3.072 | 281574.7 | 0.78 | 15.999 | 58.48 | 41.11 |
| Ti 2p | Reg | 457.800 | 2.746 | 270517.7 | 2.001 | 47.878 | 22.11 | 46.50 |
| C 1s | Reg | 285.800 | 4.182 | 28896.2 | 0.278 | 12.011 | 22.11 | 9.66 |

(BE = binding energy and FWHM = full width at half maximum)

Both samples show similar intensity in the binding energy range for iron oxide (i.e. 709.6 eV). Therefore, the contamination levels of the product obtained from the method of Example 1 has a similar low contamination level to traditional products but is obtained by a safer, lower cost and greatly simplified fabrication method.

In conclusion, the products of Example 1 have been characterized using EDX analysis, SEM imaging, EELS mapping, and XPS analysis. A visible light photocatalyst consisting of titanium dioxide doped with iron oxide is obtained from the method of Example 1. More specifically, a structure consisting of TiO₂ doped with 0.25 to 5 molar % of Fe that has greater than 75% of its surface free from iron oxide contamination. The quality of the product obtained is equivalent to the product obtained by the traditional methods and is obtained without acid washing thanks to the optimum mixing, rapid solvent removal and drying method described.

### EXAMPLE 3

### Photocatalyst Mediated Remediation Analysis

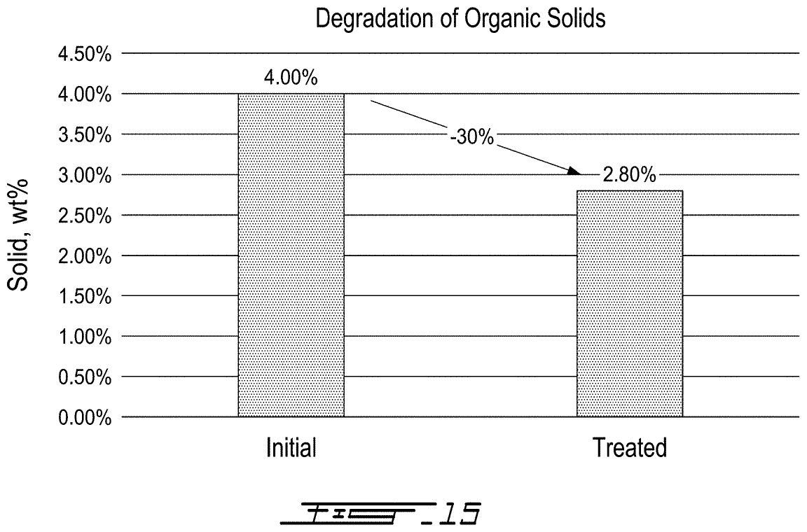

Two effluents were prepared containing 250,000 CFU/100 mL Escherichia coli. One effluent was subjected to an eight-hour treatment with photocatalysts of Sample 1. The other effluent was left untreated as negative control. The treatment consisted of adding photocatalyst product of Sample 1 to the contaminated effluent in a concentration of 3 g/L. The effluent and photocatalyst were then mixed in a turbulent environment such that the photocatalyst was kept in suspension in a homogeneous distribution. Six fifty-watt xenon light bulbs surrounded the container containing the effluent and photocatalyst. The xenon bulbs were set 15 cm from the beaker and are aimed at the centre of the effluent to activate the photocatalysts using light. Escherichia coli counts dropped to under 100 CFU/100 mL in the treated effluent as shown in FIG. 13 whereas the level of Escherichia coli remained at 250,000 CFU/100 mL for the untreated effluent.

Two effluents were prepared and had a Biochemical Oxygen Demand (BOD) of 1270 mg/L. One effluent was treated and the other was left untreated as a negative control. The treatment consisted of adding the photocatalyst product of Sample 1 to the effluent in a concentration of 3 g/L. The effluent and photocatalyst were then mixed in a turbulent environment such that the photocatalyst was kept in suspension in a homogeneous distribution. Six fifty-watt xenon light bulbs surrounded the beaker containing the effluent and photocatalyst. The light bulbs generated light to active the photocatalyst. As shown in FIG. 14, after an eight-hour treatment, the BOD dropped to 6.8 mg/L (5-Day). Biochemical Oxygen Demand is an important water quality parameter because it provides an index to assess the effect discharged wastewater will have on the receiving environment. The higher the BOD value, the greater the amount of organic matter or “food” available for oxygen consuming bacteria.

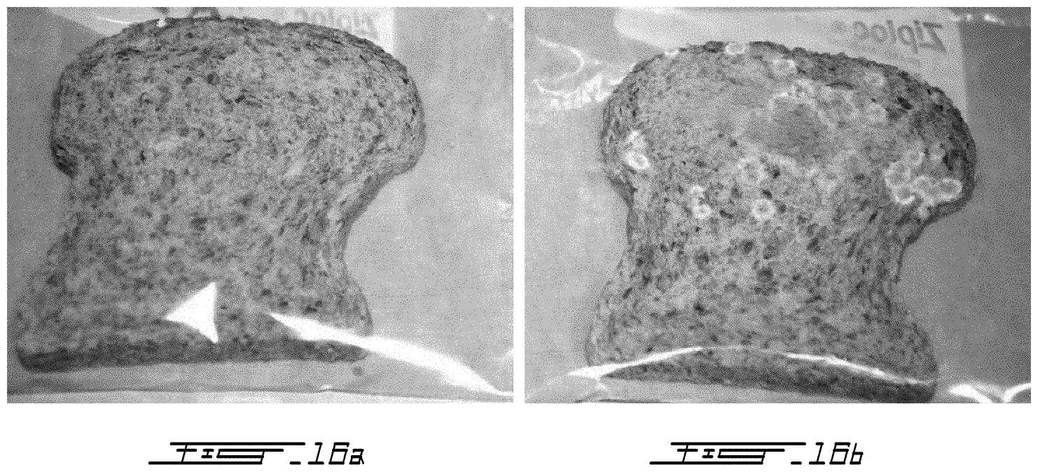

The effective degradation of organic solids in an aqueous slurry was investigated. An initial 4% organic solids slurry was prepared by acquiring brewery effluent and drying off all the solvent. The mass of the dried solids was then recorded. Next, the solids were added to water in a 4% concentration. The slurry was then treated for 8 hours. The treatment consisted of adding photocatalyst product of Sample 1 to the slurry in a concentration of 3 g/L. The slurry and photocatalyst were then mixed in a turbulent environment such that the photocatalyst and organic solids were kept in suspension in a homogeneous distribution. Six fifty-watt xenon light bulbs surround the beaker containing the effluent and photocatalyst. As shown in FIG. 15, after an eight-hour treatment, the solids content (by weight) dropped from 4% to 2.8%, a 30% reduction.

### EXAMPLE 4

### Mold Growth on Bread

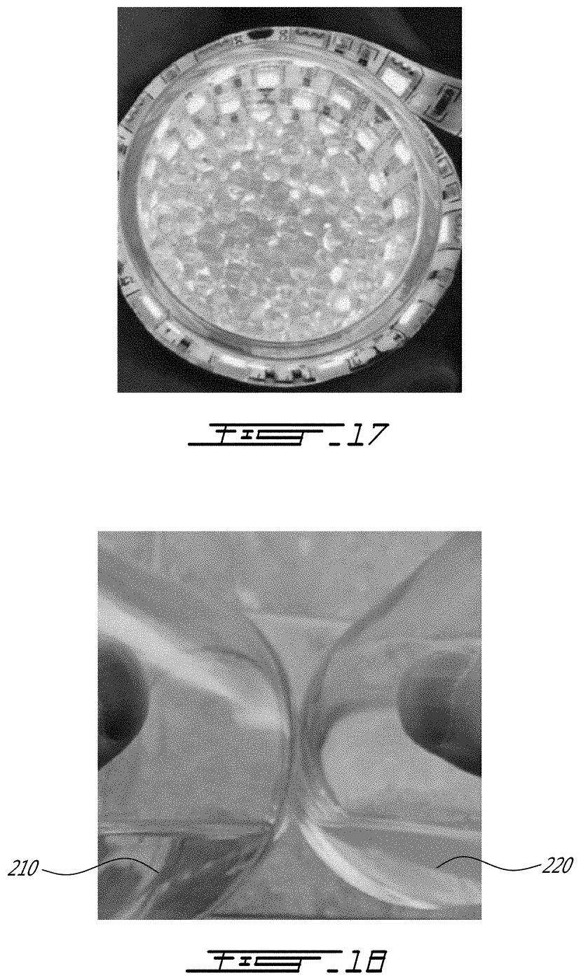

Mould growth mitigation on bread was investigated. One piece of bread was treated, the “treated” bread. The treatment consisted of misting on each side approximately 1.5 mL of a dispersion of a photocatalyst described herein with a concentration of 3 grams of photocatalyst to 1 liter of distilled water. For the “untreated bread”, each side was misted with approximately 1.5 mL of distilled water. After misting the fresh bread slices, they were placed in individual Ziploc bags. The bags were left open for 30 minutes, then sealed, and placed side-by-side on a kitchen counter. Only ambient light was used in the treatment. The photograph was taken after 7 days. FIG. 16a shows the effective mitigation of mould growth in the treated sample versus the untreated sample having significant mould growth as shown in FIG. 16b.

### EXAMPLE 5

### Methyl Orange Pollutant Remediation

Glass spheres were coated with the photocatalyst described herein. The spheres were then placed inside a glass beaker. LED light strips were wrapped around the glass beaker and turned ON, as shown in FIG. 17. A 21 mg/L solution of methyl orange was then poured into the beaker for a 60-minute treatment. The methyl orange was used as a illustrative organic pollutant. After the 60-minute treatment, the methyl orange solution was decanted and the colour compared to the baseline colour. FIG. 18 illustrates a visibly lighter colour signalling that the coated spheres were actively breaking down the organic pollutant. This demonstrates an approach for a photoreactor where the photocatalyst is immobilized on glass spheres.

The Fe-doped TiO₂ photocatalyst herein can be used:

1) to treat organic waste in wastewater using visible light,

2) to treat contaminated aqueous or non-aqueous (for example, but not limited to, ammonia and alcohols) solutions, dispersions, or slurries using visible light,

3) to treat viruses and microbial contamination in air using visible light,

4) to remove odours from air using visible light,

5) on ceramics, flooring, concrete and countertops to prevent mould and microbial growth using visible light,

6) in inorganic coatings on walls and ceilings to clean air using visible ambient light,

7) in an inorganic coating that is applied to walls and ceilings for active cleaning of surfaces and air using ambient lighting,

8) in an inorganic coating that is applied to the inside surfaces of ducting. Light bulbs are inserted into the ducting to provide the photons that activate the coating. This effectively transforms ducting into a photoreactor for mitigating odours and killing bacteria and viruses. This can be used in cannabis operations, mushroom and chicken farms, urban composting centers, and residential air cleaners,

9) in a dispersion of water and photocatalyst in a concentration of 3 g of photocatalyst per litre of water. The dispersion can be sprayed onto concrete, countertops, roofing, decking, walls or flooring to mitigate mold, algae, and moss build-up,

10) to treat water contaminated with any of the following difficult to degrade materials: fire retardants, testosterone, estrogen, polychlorinated biphenyls or pharmaceuticals,

11) in a coating coated onto the inside of a glass tube or pipe with photocatalyst. A light source can be introduced into the exterior of the glass tube or pipe. Contaminated water can be treated by flowing the contaminated water through the tube or pipe, and

12) in the remediation of an aqueous or non-aqueous (for example, but not limited to, ammonia and alcohols) solution, dispersion, or slurry comprising one or more of organic matter, at least one microbe, at least one organic compound and at least one organometallic compound is provided, having fabricated the photocatalyst comprising iron-doped titanium dioxide nanocrystals which have a low iron oxide content from the outset of the synthesis process.

There is provided a method of remediating an aqueous or non-aqueous (for example, but not limited to, ammonia and alcohols) solution, dispersion, or slurry. The aqueous or non-aqueous solution, dispersion, or slurry includes at least one of an organic compound, an organic matter, a microbial contamination, a bacterial contamination or at least one organometallic compound. Firstly, the aqueous or non-aqueous solution, dispersion, or slurry is exposed to the Fe-doped TiO₂ photocatalyst herein. In a preferred embodiment, exposing comprises mixing and suspending the photocatalyst in the solution, dispersion or slurry. In another preferred embodiment, exposing comprises flowing the solution, dispersion or slurry over a surface on which the photocatalyst is immobilized. In a third preferred embodiment, exposing comprises embedding, blending, or incorporating the photocatalyst in an inorganic coating or paint. Lastly, the photocatalyst is activated using light (for example visible light), thereby remediating the aqueous or non-aqueous solution, dispersion, or slurry and producing at least one remediation product.

As can be seen therefore, the examples described above and illustrated are intended to be exemplary only.

What is claimed is:

1. A method for producing an iron doped titanium dioxide (Fe-doped TiO₂) photocatalyst, the method comprising the steps:
a) dissolving a compound comprising Fe (III) in an aqueous medium to obtain a ferric solution comprising ferric ions;
b) mixing a C₁-C₄ substituted or unsubstituted alcohol to the ferric solution to obtain a mixture comprising the ferric ions dissolved in an alcoholic solvent, the alcoholic solvent comprising the aqueous medium and the C₁-C₄ substituted or unsubstituted alcohol;
c) adjusting the pH of the mixture by adding a suitable acid to the mixture to obtain an acidic composition having an acidic pH;
d) producing a gelation reaction by mixing a titanium (IV) complex selected from the group consisting of titanium alkoxide, titanium tetrachloride, and combinations thereof to the acidic composition, to obtain a dispersion, the dispersion comprising Fe-doped TiO₂, wherein the titanium alkoxide has a structure (i) 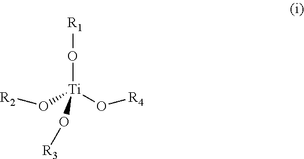
wherein R₁, R₂, R₃, and R₄ are each, identical or different, independently a substituted or unsubstituted straight or branched C₁-C₄ group;
e) drying the dispersion while removing the alcoholic solvent, to obtain a dried product substantially free of iron oxide contamination;
f) grinding the dried product, to obtain a powder;
g) washing the powder with an aqueous liquid, to obtain a washed powder comprising a Fe-doped TiO₂ photocatalyst precursor; and
h) drying the washed powder, to obtain the Fe-doped TiO₂ photocatalyst precursor.

2. The method according to claim 1, further comprising the steps
i) calcining the Fe-doped TiO₂ photocatalyst precursor, to obtain a calcined substance (189) comprising an Fe-doped TiO₂ photocatalyst; and
j) grinding the calcined substance to obtain the Fe-doped TiO₂ photocatalyst.

3. The method according to claim 1, wherein the compound comprising Fe (III) is at least one of ferric nitrite and ferric chloride.

4. The method according to claim 1, wherein the C₁-C₄ substituted or unsubstituted alcohol is one of ethyl alcohol, 2-propanol, or butanol.

5. The method according to claim 1, wherein the titanium (IV) complex is at least one of titanium tetraisopropoxide, titanium isobutoxide, and titanium tert-butoxide.

6. The method according to claim 1, wherein the suitable acid is selected from the group consisting of HNO₃, HCl, and glacial acetic acid.

7. The method according to claim 1, wherein the Fe-doped TiO₂ photocatalyst precursor has a structure consisting of TiO₂ doped with 0.25 to 20 molar % of Fe comprising a surface wherein greater than 75% of the surface is free from iron oxide contamination.

8. The method according to claim 1, wherein the acidic pH is less than 2.

9. The method according to claim 1, wherein in step d) adding the titanium (IV) complex to the acidic composition is done in less than 25 minutes.

10. The method according to claim 1, wherein step d) lasts for about 1.5 to about 2.5 hours at a temperature of about 30° C. to about 40° C.

11. The method according to claim 1, wherein the drying of step h) is performed at a temperature of about 75 to about 85° C. for 2 to 8 hours.

12. The method according to claim 1, wherein the alcoholic solvent in step e) is removed in less than 10 minutes.

13. The method according to claim 1, wherein the alcoholic solvent in step e) is removed using a conveyor process.

14. The method according to claim 13, wherein the conveyor process is a belt filtration.

15. The method according to claim 1, wherein the grinding is ball milling or jet milling.

16. The method according to claim 1, further comprising step e1), after step e) before step f), spreading the dispersion onto drying pans.

17. The method according to claim 1, wherein the washing in step g) comprises at least one wash cycle, the wash cycle comprising placing the powder in a mix vessel comprising a bottom surface, adding the aqueous liquid to the mix vessel, mixing the aqueous liquid and the powder to form a wash dispersion, allowing the powder to settle at the bottom surface of the mix vessel to form an effluent, and decanting and discarding the effluent.

18. The method according to claim 1, wherein the washed powder in step h) is dried for 2 to 6 hours at a temperature of about 50° C. to about 80° C.

19. The method according to claim 2, wherein the calcining in step i) is performed for 4 hours at a peak temperature of 400° C.

20. A method for producing an iron doped titanium dioxide (Fe-doped TiO₂) photocatalyst, the method comprising the steps:
a) dissolving a compound comprising Fe (III) in an aqueous medium to obtain a ferric solution comprising ferric ions;
b) mixing a C₁-C₄ substituted or unsubstituted alcohol to the ferric solution to obtain a mixture comprising the ferric ions dissolved in an alcoholic solvent, the alcoholic solvent comprising the aqueous medium and the C₁-C₄ substituted or unsubstituted alcohol;
c) adjusting the pH of the mixture by adding a suitable acid to the mixture to obtain an acidic composition having an acidic pH;
d) producing a gelation reaction by mixing a titanium (IV) complex selected from the group consisting of titanium alkoxide, titanium tetrachloride, and combinations thereof to the acidic composition, to obtain a dispersion, the dispersion comprising Fe-doped TiO₂, wherein the titanium alkoxide has a structure (i) 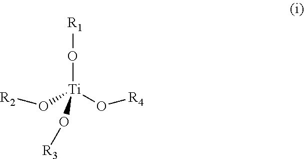
wherein R₁, R₂, R₃, and R₄ are each identical or different independently a substituted or unsubstituted straight or branched C₁-C₄ group;
e) drying the dispersion while removing the alcoholic solvent, to obtain a dried product substantially free of iron oxide contamination;
f) grinding the dried product, to obtain a powder;
g) washing the powder with an aqueous liquid, to obtain a washed powder comprising a Fe-doped TiO₂ photocatalyst precursor;
h) drying the washed powder, to obtain the Fe-doped TiO₂ photocatalyst precursor;
i) calcining the Fe-doped TiO₂ photocatalyst precursor, to obtain a calcined substance comprising an Fe-doped TiO₂ photocatalyst; and
j) grinding the calcined substance to obtain the Fe-doped TiO₂ photocatalyst.
